(19) United States
(12) Patent Application Publication
(10) Pub. No.: US 2023/0417918 A1
(43) Pub. Date: Dec. 28, 2023

(54) SMART ADAPTIVE PROCESS FOR CAPTURING 3D SURFACE GEOMETRY

(71) Applicant: THE CURATORS OF THE UNIVERSITY OF MISSOURI, Columbia, MO (US)

(72) Inventor: Kenneth J. BOYKO, Newburg, MO (US)

(21) Appl. No.: 18/026,778

(22) PCT Filed: Nov. 17, 2021
(86) PCT No.: PCT/US2021/059035

§ 371 Date: Mar. 16, 2023

Related U.S. Application Data
(60) Provisional application No. 63/114,805, filed on Nov. 17, 2020.

(51) Int. Cl. G01S 17/894; G01S 17/42; G02B 26/10

(52) U.S. Cl. CPC G01S 17/894; G01S 17/42; G02B 26/101

(57) ABSTRACT

An adaptive three-dimensional (3D) scanner having a light source configured to transmit light onto a surface according to a scanning pattern. A detector receives at least a portion of the light scattered by the surface. A processor is configured to determine, as a function of the received light, a distance between the light source and the surface and dynamically vary during scanning an angle at which the light is transmitted relative to a predefined coordinate system. In this manner, the processor repeatedly defines adjacent scan areas on the surface that are substantially equal in size.

### CROSS-REFERENCE TO RELATED APPLICATION

This application claims priority from U.S. Provisional Patent Application No. 63/114,805, filed Nov. 17, 2020, the entire disclosure of which is incorporated herein by reference.

### BACKGROUND

Aspects of the present disclosure relate generally to three-dimensional (3D) scanning.

Most 3D scanners employ a distance-measuring laser directed by a spherical/polar mechanism and use a fixed angular step increment as the object or surface that is being scanned. Unfortunately, this technique results in areas having both over-representation and under-representation of points. Once the user selects the desired angular resolution and initiates the scan, the 3D scene is captured without regard to the actual geometric nature of the surface being acquired. This results in four problems:
(1) Surfaces that happen to be close to the scanner are represented by an overabundance of points, which wastes time and energy, and results in needlessly large output files.
(2) Surfaces that are far from the scanner are not fully represented. Due to the fixed angular acquisition strategy, the spacing of the points increases with distance resulting in a loss of critical detail for surfaces far from the scanner. Sparse coverage in critical areas can often result in the need to re-scan.
(3) Due to the spherical mechanical design, surfaces near the polar regions (in line with the longitudinal axis of the scanner) are also represented by an overabundance of points.
(4) Surfaces which happen to be nearly parallel to the radial direction of scanning are severely underrepresented by points. This is also due to the fixed angular step-over strategy.

Typically, the workaround employed to address underrepresented areas is to simply increase the angular resolution. This technique results in two additional problems:
(5) The time required to discover that underrepresentation has occurred requires rescanning, further consuming time and energy.
(6) Simply increasing the angular resolution will make the areas overrepresented even worse, resulting in extremely large output files.

These issues can be somewhat mitigated by setting up the scanner in an optimal position relative to the surface being scanned. For example, if the scanner is set up centered on the surface and roughly equidistant from all surfaces, the degree of under or overrepresentation can be minimized. However, there are many situations where it is not feasible to set up the scanner in such an optimal position relative to the surface. For example, there may be physical constraints that limit the freedom to place the scanner in an optimal position. In many cases (e.g., scanning of an open cavity in a mine, cave, or collapsed building), the surfaces to be scanned are completely unknown. In these cases, the scan takes place with no ability to reposition the scanner to a more optimal position, as the access point is normally very restricted.

### SUMMARY

Aspects of the present disclosure provide an adaptive equal-area scanning approach that overcomes the shortcomings of conventional three-dimensional (3D) scanning.

An improved method of scanning a surface takes into consideration the geometric nature of the surface as it is being scanned. Instead of producing a geometric representation of a surface with points that were acquired using an equal-angular method, a process that generates equal-area representative points having near-even spacing on the actual object surface is far superior. For example, a 3D LiDAR (light detection and ranging) scanner embodying aspects of the present disclosure includes driver software for generating an equal-area density point cloud. Such a LiDAR scanner is optimally configured to execute an Equal-Area Algorithm employing a synchronous approach within the driving firmware, use low mass front-surface mirrors to direct the LiDAR laser, and use dynamic micro-stepping to achieve high servo speed while retaining high resolution. Additional factors such as using a LiDAR with a fast single point data acquisition rate and a digital communication method are contemplated.

In an aspect, a method of three-dimensional (3D) scanning includes transmitting light from a light source onto a surface under inspection according to a scanning pattern. The method further includes detecting at least a portion of the light scattered by the surface and determining, as a function of the detected light, a distance between the light source and the surface. Based on the determined distance, the method includes dynamically varying an angle at which the light is transmitted relative to a predefined coordinate system to repeatedly define scan areas on the surface that are adjacent each other and substantially equal in size.

In another aspect, a method of 3D LiDAR scanning includes transmitting light from a light source onto a surface under inspection according to a scanning pattern. The scanning pattern initially defines an initial polygon on the surface. The method further includes detecting at least a portion of the light scattered by the surface at the initial polygon and determining, as a function of the detected light, a distance between the light source and the surface at the initial polygon. Based on the determined distance, the method includes dynamically adapting the scanning pattern. The adapted scanning pattern repeatedly defines polygons on the surface that are adjacent each other and substantially equal in size. The method also includes transmitting the light incident upon the surface at the adjacent polygons according to the adapted scanning pattern.

In yet another aspect, a LiDAR scanner comprises a light source configured to transmit light onto a surface according to a scanning pattern. A detector receives at least a portion of the light scattered by the surface. A memory device stores computer-executable instructions that, when executed by a scan processor, configure the scan processor to determine, as a function of the received light, a distance between the light source and the surface and dynamically vary during scanning an angle at which the light is transmitted relative to a predefined coordinate system. In this manner, the processor repeatedly defines scan areas on the surface that are adjacent each other and substantially equal in size.

Other objects and features will be in part apparent and in part pointed out hereinafter.

### BRIEF DESCRIPTION OF THE DRAWINGS

FIG. 1 illustrates a fixed angular resolution scan according to the prior art.

FIG. 2 illustrates a smart adaptive variable resolution scan according to an embodiment.

FIG. 3 is a block diagram illustrating a three-dimensional (3D) scanner according to an embodiment.

FIGS. 4A and 4B illustrate a comparison of an equal angular approach and an equal-area approach, respectively, using a spherical void volume.

FIGS. 5A and 5B illustrate a comparison of an equal angular approach and an equal-area approach, respectively, using a cuboid void volume.

FIG. 6 is a block diagram of an example architecture for software configured for comparing the adaptive equal-area approach according to an embodiment to the fixed equal angle approach according to the prior art.

Corresponding reference characters indicate corresponding parts throughout the drawings.

### DETAILED DESCRIPTION

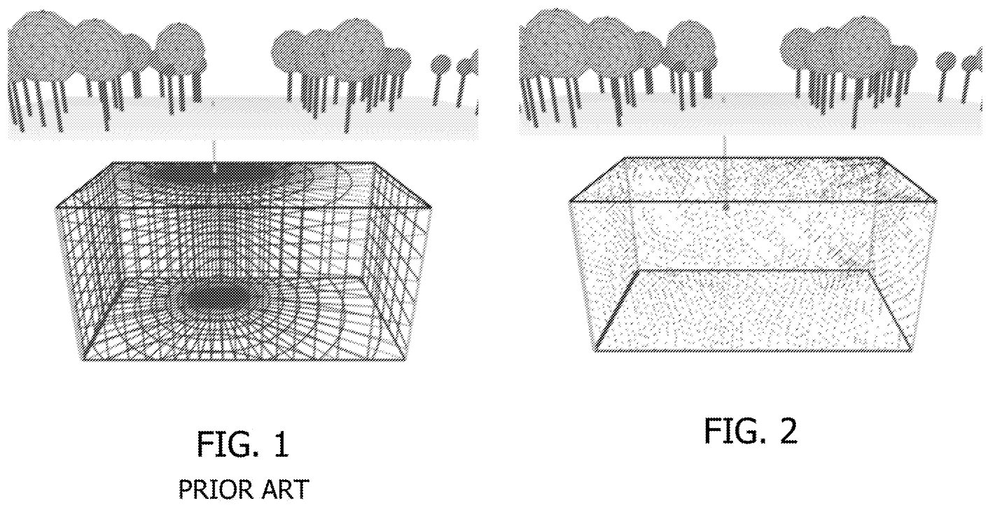

FIG. 1 illustrates a conventional scanning approach using a fixed angular resolution strategy. In contrast, FIG. 2 illustrates a smart adaptive process using variable angular resolution and enforcing an equal-area principle in accordance with aspects of the present disclosure. Improved scanning of a surface takes into consideration the geometric nature of the surface as it is being scanned. Instead of producing a geometric representation of a surface with points that were acquired using a conventional equal-angular method, aspects of the present disclosure generate equal-area representative points having near-even spacing on the actual object surface, producing far superior results.

For example, a three-dimensional (3D) LiDAR scanner embodying aspects of the present disclosure includes driver software for generating an equal-area density point cloud. According to an embodiment, the equal-area approach reduces the number of representative points by a factor of 10 to 15, for example, compared to conventional techniques, while resulting in automatic densification or thinning where needed due to distance, polar proximity, or radial surface orientation. This not only dramatically speeds up scanning time, but eliminates the need for rescanning due to areas not being sufficiently represented. Finally, the elimination of spurious overrepresented points makes the resultant point cloud files much smaller, speeding up the software used for post scanning analysis.

A typical scanning rate of 300 points (x,y,z triplets) per second results in 3.3 milliseconds, or 3,300 microseconds between each point. Instead of using the time between points to simply step over a fixed angular amount, a microcontroller analyzes the geometry of the local surface being scanned within this short interval and then directs the acquisition of the next point to satisfy the equal surface area criteria. Instead of blindly scanning a surface without regard to its actual geometry, this smarter process controls the scanning process during the scan, resulting in an automatic near-even distribution of representative points.

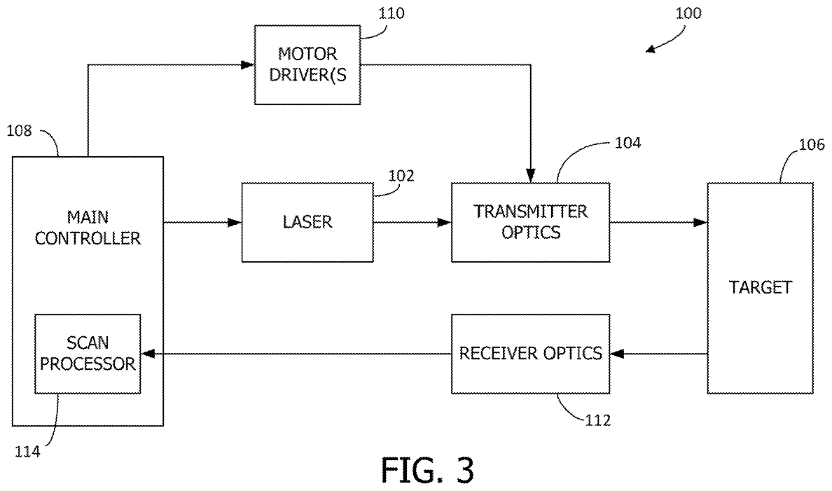

FIG. 3 is a schematic block diagram illustrating a LiDAR system 100 in accordance with an embodiment. In general, the LiDAR system 100 includes a transmitter, a receiver, an optical system, and a control and processing unit. In the illustrated embodiment, LiDAR system 100 uses a diode laser or diode-pumped solid-state laser or the like, indicated as laser 102, to transmit a light pulse to transmitter optics 104. The transmitter optics 104 help the system 100 focus the transmitted light onto a target 106. A main controller 108 controls the motion of the transmitter optics 104 via motors 110. Some of the light reflects off of the target 106 and receiver optics 112 receive the back scattered light reflected from the target 106. A scan processor 114 processes the light from receiver optics 112 to measures the amount of back scattered light as a function of distance.

There are many approaches that could be taken to achieve such a smart scanning strategy. The results according to an embodiment using a synthetic representation of a rectangular underground void and a recursive fractal pattern approach for the adaptive method are shown below. The adaptive approach resulted in a 13.7 times reduction in the number of representative points, and a more even point distribution.

Conventional approaches require three separate steps: initial data acquisition, object model formation, and finally, analysis of the object model. Advantageously, acquisition and analysis of 3D surface information in accordance with embodiments of the present disclosure effectively combine the first two steps, producing an object model directly during the scanning process.

As autonomous navigation technologies advance, there will be a need for smart scanners to directly create object models, instead of requiring a separate process to transform a raw scan point cloud into an object model. Direct model creation enhances such capabilities as object recognition, collision avoidance, and optimum path planning. This advances the trend of smart sensors and smart cameras, in that the output of such devices is no longer merely raw data, but actionable intelligence directly in model form.

Aspects of the present disclosure are applicable to a wide variety of applications that share the common problem of trying to scan a surface with limited or no a priori knowledge of the surface geometry. An automated adaptive approach to surface scanning takes advantage of the power of microcontrollers to analyze the surface of target 106 as it is being scanned to optimize point spacing, scanning speed, and output file size. Output files produced by 3D scanners commonly are tens of gigabytes in size. Even modest improvements in scanning efficiency is a useful improvement. The disclosed method reduces the number of representative points and output file size by, for example, an order of magnitude.

The LiDAR scanner system 100 according to an embodiment is optimally designed for an Equal-Area Algorithm executed by the scan processor 114. In this instance, the system 100 employs a synchronous approach within the driving firmware, uses low mass front-surface mirrors of transmitter optics 104 to direct the LiDAR laser 102, and uses dynamic micro-stepping of motors 110 to achieve high servo speed while retaining high resolution. Additional factors such as using a LiDAR with a fast single point data acquisition rate and a digital communication method are contemplated.

Broadly speaking, the total scan time for a given field of view is a function of the number of LiDAR points acquired and the total linear angular path of the LiDAR laser 102 actuators. Other subordinate factors include the mechanical design of the 2-axis actuator, the data acquisition rate of the laser distance measuring device, the speed and torque of the actuator servo motors 110, the mass of the movable parts of the scanning mechanism, and the degree to which a variable step resolution strategy is employed. Finally, the choice of using either a synchronous or asynchronous approach in the driving firmware is also a major factor. Each of these factors is described in detail below.

### Minimizing the Number of LiDAR Points

To minimize the total scan time, the number of LiDAR points acquired should be the smallest number required to completely describe the surface of target 106 being scanned. In an embodiment, an equal-area scanning pattern on the surface itself satisfies this condition. Using an equal-area approach means that no part of the surface is over—or under represented by points; in other words, the point density on the scanned surface itself is roughly equivalent on all areas of the surface.

A scanning pattern like the one produced by the equal-angular approach results in an over-abundance of points near the polar (nadir and zenith) regions and on surfaces which are physically close to the LiDAR system 100. On the other hand, there is a deficiency of points on surfaces that are either physically far removed from the LiDAR system 100 or fall on surfaces nearly parallel to the LiDAR beam direction. The Equal-Area Algorithm eliminates all of these issues.

### Mechanical Design of the 2-Axis Actuator

Most LiDAR scanners employ some variation of the azimuth-altitude mount, where the horizontal and vertical rotational axis are orthogonal to each other. This configuration results in a spherical or polar geometry where the horizontal axis represents the longitudinal angle, and the vertical axis represents the polar angle. The vertical and horizontal angles are analogous to the latitude and longitude grid lines on a globe. The spherical coordinate system results in a natural convergence of the meridians at the polar regions. Therefore, if the horizontal and vertical axis are treated as Cartesian (X & Y) coordinates, the polar regions will be covered by an over-abundance of representative LiDAR points.

### Data Acquisition Rate of the LiDAR Laser

The difference between the wide-open streaming rate of the distance measuring LiDAR device and the speed of a single distance acquisition is a factor in determining the relative efficiency of synchronous and asynchronous modes of operation (see discussion below). The Equal-Area Algorithm of the present disclosure requires a fast single distance measurement process and the ability to either trigger an acquisition on command, or to read distance and status registers to obtain the latest distance if the device is operating in a continuous stream mode.

The internal method of communication at the hardware level is also a factor. Digital methods such as high speed mode I2C (Inter-Integrated Circuit) or SPI (Serial Peripheral Interface) is preferable over analog methods such as PWM (Pulse-Width Modulation).

### Speed and Torque of the Actuator Servo Motors

In an embodiment, the motors 110 are fast, responsive, and high torque servo motors having low latency and small dead bands and therefore are optimal for use with the Equal-Area approach, due to the increased total path length, potential for a higher percentage of rotation reversals, and wider disparity in range of motion between each single point acquisition. High torque helps to overcome the inertial mass of the moving components. Aggressive ramping and fast closed-loop PID (Proportional-Integral-Derivative) settings also contributes to quick response times with minimal ringing.

### Mass of the Movable Parts of the Scanning Mechanism

With some designs, the entire LiDAR mechanism is rotated within two nested supporting axes. While conceptually simple, this design choice requires the use of electrical slip rings or a radio link to communicate the distance measurements and inside motor commands to the base-mounted electronic circuitry. In addition, this design requires the servo motors to quickly move the entire mass of the LiDAR mechanism, which requires higher powered servo motors. In an embodiment, the LiDAR mechanism is placed with the base-mounted electronics and employs low-mass front surface mirrors, i.e., transmitter optics 104, to direct the beam of the LiDAR laser 102 during the 2-axis scanning. This embodiment has the advantage of having far less mass in the moving components, and thus, is configured to achieve higher scanning speeds. In addition, the lower mass makes path reversals easier to manage, as the torques required for acceleration and deceleration is less.

### Fixed vs. Variable Resolution Strategies

Most LiDAR drive mechanisms used a fixed servo gear ratio and step size selected to provide the best over-all performance for a given set of applications. While changing the mechanical gear ratio is not practical, most servo drivers do allow for micro-stepping which changes the ratio of input to output step size. Even when micro-stepping is provided, most LiDAR firmware uses static micro-stepping (employing a fixed step size). However, the capability of dynamic micro-stepping (changing the micro-stepping level on the fly) during the scan is technically permitted. With static micro-stepping, a low step setting will always be faster, but at the cost of lower resolution. A high step setting will have higher resolution, but will be slower. If implemented properly, dynamic micro-stepping provides the best of both worlds—providing both a higher speed while not sacrificing resolution.

### Synchronous vs. Asynchronous Driving Firmware

If the objective is to acquire the maximum number of LiDAR points per unit of time, one common technique is to let the LiDAR distance measuring device run independently at its maximum streaming acquisition rate while periodically acquiring time stamps for the distance observations. Simultaneous to this, the servo motors 110 may be also independently moving to known positions with similar time stamp information. Further, servo motors 110 may be either driven to known locations, or the locations could be derived from encoders attached to the motor shafts. The two data streams (the motor position and the LiDAR distances) are integrated using the time stamps to synchronize the observations. Acquiring LiDAR points in this fashion is considered to be using an asynchronous mode, as the motor positions and LiDAR distances are acquired independent from each other, and integrated later using the time stamp information.

The other alternative is to have main controller 108 move servo motors 110 to a particular aim direction, then trigger the acquisition of a single LiDAR distance measurement. The horizontal and vertical angles, combined with the LiDAR distance are used to compute a relative (x,y,z) coordinate (a single LiDAR point). This whole process repeats for every LiDAR point. Because the data acquisition proceeds in a controlled sequential fashion, this mode of operation is considered to be using a synchronous mode.

Since scan processor 114 uses the Equal-Area Algorithm to make decisions on where to acquire the next LiDAR point during the scanning (by analyzing the local surface geometry), it uses firmware employing the synchronous acquisition mode. While the asynchronous scanning process can achieve a higher number of points per unit of time, the synchronous scanning process used by the Equal-Area Algorithm is capable of reducing the overall scanning time, because less time is wasted acquiring redundant points.

### Results of Hardware Simulation

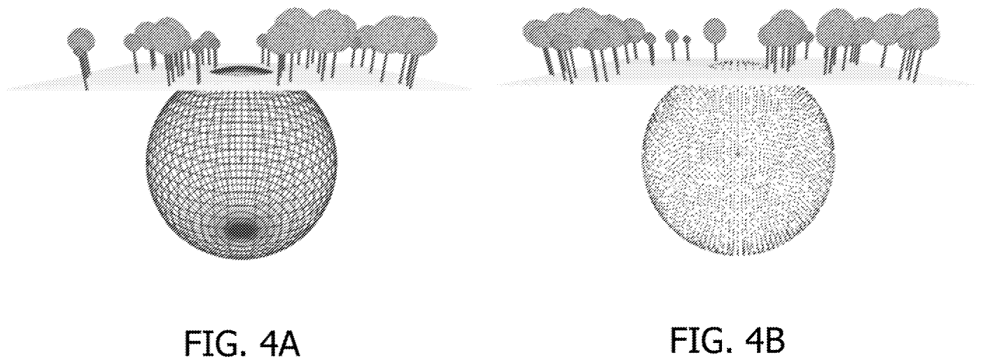

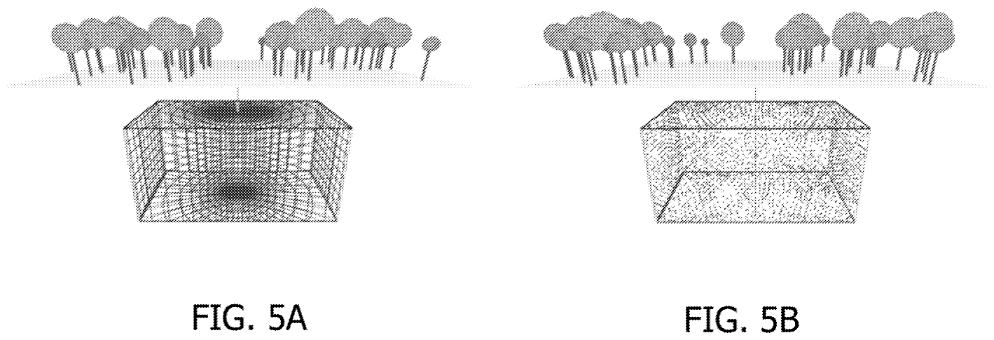

The Equal-Area Algorithm was tested using simulated hardware on a variety of void shapes and sizes. During the testing, several statistics were collected to aid in the analysis of the algorithm performance. These included the number of points acquired, maximum stack depth, counts of various types of polygons to sub-split, and the total linear angular path length accumulated during the scan. The Equal-Area Algorithm resulted in a 12-15 times reduction in the number of points acquired to represent a surface, and also resulted in a much more even distribution of those points on the surface. However, due to the recursive nature of the Equal-Area Algorithm, the total angular path length was from 1.9 to 2.2 times greater than the Equal Angular approach. The number of points and total path length is influenced by the shape of the void, but the ratios are similar as illustrated by FIGS. 4A-4B and 5A-5B. Even though the total path length is greater by roughly a factor of 2, the reduction in number of points by a factor of approximately 13 results in an overall decrease in scanning time.

### High Level Algorithm Description and Source Code

Most scanners use a fixed equal angular pattern for scanning. Once the scanning parameters (pattern, resolution, and extent) are set, the scanning proceeds using a fixed angular step-over without regard to the characteristics of the surface being scanned. The only computation performed between the acquisition of each LiDAR point is to advance the servo motors by some fixed angular interval. With the adaptive process of the present disclosure, after each LiDAR point is acquired, the local surface of target 106 is analyzed to determine the aim direction to be used for acquiring the next point. The scanning pattern is automatically adapted to the geometry of the 3D surface being scanned during the scanning process.

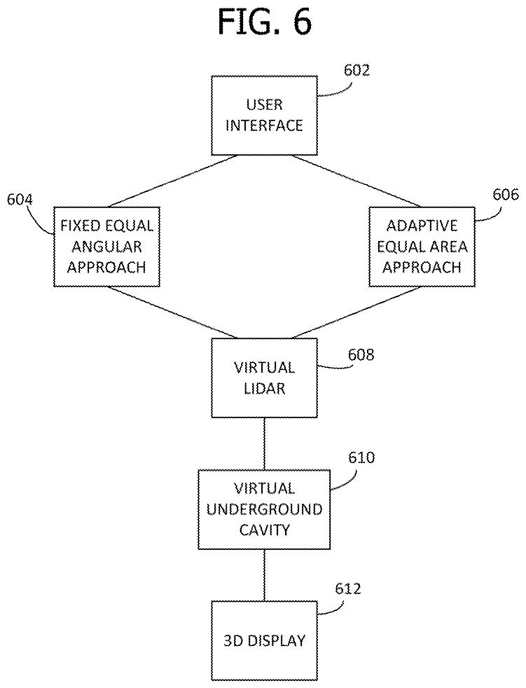

FIG. 6 is a block diagram of an example architecture for software configured for comparing the adaptive equal-area approach according to an embodiment to the fixed equal angle approach according to the prior art. A user interface 602 selects scan results of a fixed angular approach (e.g., FIGS. 4A, 5A) at 604 for comparison against scan results of a fixed area approach (e.g., FIGS. 4B, 5B) at 606. Testing in this example has been accomplished within a simulated environment, using a simulated LiDAR at 608 and a virtual underground cavity at 610. The size and shape of the cavity, and the location of the LiDAR scanning head within the cavity are configurable. Also configurable are the operational parameters such as the maximum surface point spacing, minimum hardware angular resolution, and parameters which define how the initial seed triangles are pushed onto the stack. The operation of the virtual LiDAR exactly matches how real (physical) LiDAR scanners operate—they are directed to aim at some orientation using horizontal and vertical servo motors, and a time-of-flight laser is fired to determine a distance to the surface being aimed at. A 3D display of the scan is generated at 612.

### High Level Algorithm

The Smart Adaptive Process according to an embodiment uses a recursive fractal approach. The recursion in this embodiment is implemented with a stack, and the fractal pattern emerges as a result of repeatedly splitting triangles into self-similar shapes. The algorithm begins by defining a space which is split into an initial set of seed triangles. The space used in the current demonstration software represents a whole sphere, split into eight large spherical triangles. In an alternative embodiment, a window is defined representing some angular subset (horizontal min-max and vertical min-max) in addition to or instead of a whole sphere.

### Push Sequence

Before the triangle is pushed on the stack, the LiDAR 100 is directed to aim to in a direction defined by the horizontal and vertical angle of each triangle corner. The LiDAR laser 102 is triggered, capturing a distance to the surface of target 106. The horizontal angle, vertical angle, and distance are used to compute a relative (x,y,z) of the surface. After (x,y,z) coordinates are captured for each of the triangle's three corners, the triangle is pushed on a stack for future processing.

```
Adaptive Equal-Area Pseudo Code
Push initial seed triangles onto the stack
If there are triangles on the stack
  Pop a triangle off the stack
  Evaluate the triangle for size, shape, and splittability.
  If it needs to be split
    Split into small triangles and push each onto the stack
  Else
    Consider it a terminal triangle - no further action required
  Else
    Stack is empty - process is completed.
```

When process is completed, the entire surface will be covered by points which honor the maximum point spacing criteria. There may be areas which exceed this defined density, but all areas will have at least this point density.

### Statistics Maintained

To aid in debugging and analysis of algorithm variations, statistics are generated for a number of algorithmic and performance related indicators. This include counts for the various types of triangles, maximum stack depth, number of generated points, accumulative horizontal and vertical servo motion, number of horizontal and vertical servo reversals, total path length, and number of stack push/pop operations. These statistics, together with assumptions covering the data acquisition rate of an actual LiDAR device, specific servo motor speeds, and inertia of a particular mechanical design, are useful for estimating the overall scanning time required for the both the fixed equal angular and adaptive equal-area approaches over a wide range of operational configuration settings.

### Source Code Summary

Language: The software according to an embodiment is written in Processing, a high level graphics-oriented set of libraries based on JAVA.

Architecture: Referring again to FIG. 6, the software is designed to compare and contrast two approaches to scanning—the fixed equal-angular approach at 604, used by nearly all terrestrial and subterranean LiDAR scanners, and the adaptive equal-area approach at 606 in accordance with aspects of the present disclosure. The specific application is focused on scanning the interior of an air-filled underground cavity. Typical for this type of application, the user has no control over where to place the LiDAR scanning head relative to the geometry of the cavity. The LiDAR is inserted down a borehole which happens to punch into the cavity. It most likely will not be located in an optimal position, such as the center of the cavity.

The software architecture as shown in FIG. 6 can be viewed as consisting of six components: an implementation of the fixed equal-angular approach 604, an implementation of the adaptive equal-area approach 606, a user interface 602, a virtual underground void cavity 610, a virtual LiDAR scanning the interior of the void cavity 608, and a 3D display environment 612.

```
Summary of Source Code Functions
setup - Main program
draw - Processing's default loop function
keyPressed - User Interface. Defines actions for hot keys.
equalAreaScan - Implements the adaptive equal area algorithm
loadSeedTriangles - Pushes initial seed triangles onto stack
evaluateTriangle - Analyzes triangle based on size, shape, and ratios of side
  lengths and angles
splitRegularTriangle - splits normal near-isosceles triangles into four triangles
splitFatTriangle - splits obtuse triangle using a variety of methods depending
  on geometry
splitSkinnyTriangle - Stub for handling thin triangles
splitPentagonTriangle - Stub for testing pentagon method of splitting a
  triangle
pushTri - Push triangle on stack
duplicate - Tests if triangle has already been instantiated
splittable - Determines if triangle is splittable given its size, shape, and
  minimum hardware specs
populateXYZ - Determines the (x,y,z) of the virtual surface from firing the
  virtual LiDAR
driveSteppers - Moves the virtual LiDAR
acquireRange - Fires the virtual LiDAR to obtain a distance to the virtual
  surface
findMidPoint - Determines the midpoint of a 3D segment using spherical
  math
planarFindMidPoint - Determines the midpoint of a 3D segment using planar
  math
carlsonScan - Implements the fixed equal angular algorithm
carlHorScan - Implements the Carlson horizontal scanning pattern
carlVerScan - Implements the Carlson vertical scanning pattern
paintRefGrid - Paints reference grid on all six sides of the virtual void cavity
paintCavityAndLiDAR - Paints the void cavity and LiDAR position within the
  virtual void cavity
paintGroundScene - Paints ground plane, borehole, and a forest of trees
paintTree - Paints a single tree
```

APPENDIX A provides example source code implementing a recursive triangle scanning process result in equal-area distribution of points in point cloud.

Embodiments of the present disclosure may comprise a special purpose computer including a variety of computer hardware, as described in greater detail below.

For purposes of illustration, programs and other executable program components may be shown as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and process without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A method of three-dimensional (3D) scanning, the method comprising:
transmitting light from a light source according to a scanning pattern, the light incident upon a surface under inspection and scattered thereby;
detecting at least a portion of the light scattered by the surface;
determining, as a function of the detected light, a distance between the light source and the surface;
dynamically varying an angle at which the light is transmitted relative to a predefined coordinate system based on the determined distance to repeatedly define scan areas on the surface, the scan areas being adjacent each other and substantially equal in size.

2. The method of claim 1, wherein the scanning pattern initially defines one or more the scan areas on the surface, the initially defined scan areas comprising seed areas.

3. The method of claim 1, wherein the adjacent scan areas are triangles.

4. The method of claim 3, wherein transmitting the light comprises aiming the light in a direction defined by an angle of each triangle corner relative to horizontal and/or vertical.

5. The method of claim 1, further comprising assigning coordinates to positions on the surface based on the angle at which the light is transmitted relative to the predefined coordinate system and the determined distance from the light source to the surface.

6. The method of claim 5, wherein the scan areas are triangles and the assigned coordinates represent corners of the triangles.

7. A method of three-dimensional (3D) LiDAR scanning of a surface under inspection, the method comprising:
transmitting light from a light source according to a scanning pattern, the light incident upon the surface and scattered thereby, the scanning pattern initially defining an initial polygon on the surface;
detecting at least a portion of the light scattered by the surface at the initial polygon;
determining, as a function of the detected light, a distance between the light source and the surface at the initial polygon;
dynamically adapting the scanning pattern according to which the light is transmitted based on the determined distance, the adapted scanning pattern repeatedly defining polygons on the surface, the polygons being adjacent each other and substantially equal in size; and
transmitting the light incident upon the surface at the adjacent polygons according to the adapted scanning pattern.

8. The method of claim 7, wherein dynamically adapting the scanning pattern comprises varying an angle at which the light is transmitted relative to a predefined coordinate system to maintain the adjacent areas of the surface substantially equal in size.

9. The method of claim 8, further comprising assigning coordinates to positions on the surface based on the angle at which the light is transmitted relative to the predefined coordinate system and the determined distance from the light source to the surface.

10. The method of claim 9, wherein the scan areas are triangles and the assigned coordinates represent corners of the triangles.

11. The method of claim 7, wherein dynamically adapting the scanning pattern comprises performing a fractal recursion.

12. The method of claim 11, wherein performing the fractal recursion comprises repeatedly splitting the polygons into self-similar shapes for processing.

13. The method of claim 7, wherein the polygons are triangles and wherein transmitting the light comprises aiming the light in a direction defined by an angle of each triangle corner relative to horizontal and/or vertical.

15. A LiDAR scanner comprising:
a light source configured to transmit light according to a scanning pattern, the light incident upon a surface under inspection and scattered thereby;
a detector configured to receive at least a portion of the light scattered by the surface;
a scan processor; and
a memory device storing computer-executable instructions that, when executed by the scan processor, configure the scan processor to:
determine, as a function of the received light, a distance between the light source and the surface; and
dynamically vary an angle at which the light is transmitted relative to a predefined coordinate system during scanning based on the determined distance to repeatedly define scan areas on the surface, the scan areas being adjacent each other and substantially equal in size.

16. The scanner of claim 15, wherein the scanning pattern initially defines one or more the scan areas on the surface, the initially defined scan areas comprising seed areas.

17. The scanner of claim 15, wherein the adjacent scan areas are triangles.

18. The scanner of claim 17, wherein the light source is configured to aim the transmitted light in a direction defined by an angle of each triangle corner relative to horizontal and/or vertical.

19. The scanner of claim 15, wherein the memory device further stores computer-executable instructions that, when executed by the scan processor, configure the scan processor to assign coordinates to positions on the surface based on the angle at which the light is transmitted relative to the predefined coordinate system and the determined distance from the light source to the surface.

20. The scanner of claim 19, wherein the scan areas are triangles and the assigned coordinates represent corners of the triangles.
